(19) United States
(12) Patent Application Publication
(10) Pub. No.: US 2024/0009511 A1
(43) Pub. Date: Jan. 11, 2024

(54) Virtual Steering Apparatus

(71) Applicant: Watomiq GmbH, Hamburg (DE)

(72) Inventor: Niels Kristian Skov Andersen, Harrislee (DE)

(21) Appl. No.: 18/372,275

(22) Filed: Sep. 25, 2023

Related U.S. Application Data
(63) Continuation of application No. PCT/EP2022/057970, filed on Mar. 25, 2022.

(30) Foreign Application Priority Data
Mar. 25, 2021 (EP) 21164969.4

(51) Int. Cl. A63B 22/06; A63B 24/00; A63B 71/06

(52) U.S. Cl. CPC A63B 22/0605; A63B 24/0084; A63B 71/0622; A63B 2022/0641

(57) ABSTRACT

The present disclosure regards a steering apparatus for an exercise bike comprising: a connection part adapted to be secured to the exercise bike, and a holding part connected to the connection part and configured for holding an electronic sensor unit, such as a smartphone, wherein the steering apparatus is configured to have a steady state configuration where the connection part and the holding part define a first orientation relative to each other, and a steering configuration wherein an external force applied to the holding part rotates the holding part relative to the connection part defining a rotation axis of the steering apparatus.

### RELATED APPLICATIONS

This application is a Continuation of prior International Application PCT/EP2022/057970 filed 25 Mar. 2022, which claims priority to European Application No. EP 21164969.4 filed 25 Mar. 2021, the entire disclosure of each being hereby incorporated by reference herein.

### TECHNICAL FIELD

The present disclosure relates to a steering device for indoor cycle training, e.g., a stationary exercise bicycle, preferably provided with a cycling training system and a software application.

### BACKGROUND OF THE INVENTION

Being healthy is one of the important parts of a human's life. With a growing awareness of living healthily, practising regular physical activity has gained much attention. Not only does physical activity or exercise improve health and reduce the risk of developing diseases, it also increases muscle strength.

One of the earliest forms of exercise is cycling. There have been several publications referring to the advantages of cycling such as decreased risks of stroke, heart attack, some cancers, depression, diabetes and obesity. Furthermore, riding a bike is perceived as a fun way of exercising and it allows an adjustable intensity and time. Therefore, cycling appeals to a wide range of age groups.

Despite many advantages of outdoor cycling, the accessibility of riding a bike outside relies on other factors such as outdoor conditions. Bad weather conditions, infrastructure of roads and safety are some of the determining factors when cycling outdoors. Furthermore, due to increasing demands on people's lives in regards to work and family, it may be difficult to find time to exercise regularly.

In order to fulfil the needs for more accessible training conditions, the landscape of cycling has been changing during recent decades. Training bikes and indoor cycling offer a greater flexibility and practicality than outdoor cycling. One appealing factor of using exercise bikes is the possibility of tailoring a workout routine according to a daily schedule. Especially for those who own an exercise bike, the flexibility and practicality that an exercise bike offers is even greater. Additionally, exercise bikes avoid distractions such as bad weather conditions, road conditions, cars and so on, offering a safe exercising environment.

Together with this growing interest towards exercise bikes, many developments in the field have happened. With recent developments, stationary bikes are connected to software applications and virtual reality simulation technology, which makes indoor cycling a more immersive and an interactive experience.

### SUMMARY OF THE INVENTION

Simulating the feeling and flow of a traditional outdoor bicycle in an exercise bike is challenging. Most of the exercise bikes are stationary and have limited functions for simulating an outdoor cycling experience. The current technology provides a limited sense of realism because an operator of a stationary exercise bike, typically having a stationary handlebar, cannot turn the handlebar of the stationary bike during the course of a turn in a virtual digital environment. A further challenge is to provide a precise and an accessible monitoring of the virtual environment. These challenges prevent the exercise bikes from offering a convenient and a realistic cycling experience.

In a first aspect, the present disclosure relates to a (virtual) steering apparatus for an exercise bike comprising:
a connection part adapted to be secured to the exercise bike, for example adapted to be attached to a handlebar of the exercise bike, e.g. a stationary handlebar,
a holding part connected to the connection part and configured for holding—a rotation axis between the connection part and the holding part, and
an electronic sensor unit, such as a smartphone,
   wherein the virtual steering apparatus is configured to have a steady state configuration where the connection part and the holding part define a first orientation relative to each other, and a steering configuration wherein an external force applied to the holding part rotates the holding part relative to the connection part around the rotation axis of the virtual steering apparatus. Preferably such that the handlebar of the exercise bike is stationary during rotation of the holding part. Hence, the presently disclosed steering apparatus, preferably the connection part, is preferably configured for attachment to the handlebars of an exercise bike.

One advantage of the present invention is that the presently disclosed virtual steering apparatus can be attached to either a freestanding indoor bicycle, e.g. mounted in a cycle trainer, or in a stationary exercise bike. The steering configuration can be provided without the need for steering the exercise bike itself, thus the steering apparatus can be an add-on to existing exercise bikes of various kinds.

A further advantage of the disclosed steering apparatus is that the steering configuration can be established efficiently and instantaneously. For example, when the operator initiates an external force, such as gently pushing or pulling the steering apparatus, the steering configuration can be activated. This foresees that a steering action may not require a demanding effort from the operator. Typically a user on an exercise bike is participating in a digital cycling game via feedback from the exercise into the digital cycling game, such that the physical activity of the user on the exercise bike is directly associated with speed and position of the corresponding digital bicycle in the digital cycling game, the user is typically also associated with a digital user avatar in the cycling game. Typically the user is not steering the user's corresponding bicycle in the digital cycling game, the digital bicycle is normally automatically following the digital road in the digital environment such that the user can concentrate on turning the pedals on the exercise bike. However, with the presently disclosed steering apparatus the user is provided with an option of further engagement in the digital cycling game, because with the presently disclosed steering apparatus the user can follow a different, and possibly more optimal, route through a curve in the digital road, the user can better navigate the digital user avatar through a digital peloton in the digital cycling game and possibly obtain a better position in the peloton and/or lane shifting can be provided on the digital road. As soon as the user let go of the steering apparatus, preferably the steady state configuration is resumed and the digital user avatar on the digital bicycle can again be automatically controlled in the digital environment.

Additionally, the virtual steering apparatus is advantageously configured to return to its reference configuration, i.e. the configuration without steering, as soon as the external force is removed. I.e. the user of the exercise bike, typically engaged in demanding physical activity on the exercise bike, does not need to perform an extra action or apply extra force to return the steering apparatus to the starting point. Thus, the presently disclosed steering apparatus provides a user-friendly mechanism that can be enjoyed by people of all ages, from young children to older adults and people of various physical conditions.

The present disclosure further relates to a cycling exercise system comprising the presently disclosed steering apparatus and a computer program having instructions, which, when executed by a processing unit, cause the processing unit to:
receiving tilting data from an electronic sensor unit attached to the holding unit of the virtual steering apparatus, when the virtual steering apparatus is in the steering configuration,
processing the tilting data by means of the remote processing device to provide real-time steering data representing steering of a digital bicycle in a virtual cycling game.

In order to have an entertaining and engaging virtual reality cycling experience, it may be desirable to have a system, which provides an experience as close as possible to the real cycling experience. The disclosed exercise system may therefore be provided with a screen or a monitor installed in front of the operator and a computer program/software application simulating a digital cycling environment, and/or a digital cycling game.

Advantageously, the software of virtual cycling application or a game can be executed on a remote processing device, which is attached to the steering apparatus or merely wirelessly connected. Consequently, tilting the steering apparatus would affect the orientation of the remote operating device such that instantaneous tilting data can be received and processed for steering the virtual bike. The tilting data may be steering data or turning data. Furthermore, the operator can initiate a series of bicycle riding movements such as left turning, right turning and changing lane in a digital cycling environment.

Yet a further aspect relates to an exercise bike comprising the cycling exercise system, wherein the presently disclosed steering apparatus is secured to the handlebar of the exercise bike, i.e. such that the handlebar of the exercise bike can be or remain stationary during tilting of the steering apparatus.

Initiating a series of bicycle riding movements usually occurs while pedalling on the exercise bike. When cycling at high pace at varying resistance levels and encountering various obstacles while performing multiple turns and shifting lanes in the virtual environment, the operator needs a cycling training system that provides an efficient steering apparatus while ensuring a close-to-reality cycling experience.

Consequently, it is a further advantage that the presently disclosed invention relates to a stable platform for simulating a cycling environment where the operator experiences three-dimensional motion and pedalling similar to that of riding a real bicycle outdoors while permitting tilting of the virtual steering apparatus.

### DESCRIPTION OF THE DRAWINGS

In the following the invention will be described in greater detail with reference to the accompanying drawings:

FIG. 1A shows one embodiment of an isometric view of the virtual steering apparatus.

FIG. 1B shows one embodiment of a back view of the virtual steering apparatus.

FIG. 2 is one embodiment of the virtual steering apparatus when the connection part and the holding part are disassembled.

FIG. 3 is one embodiment of the connection part showing a magnetic connection.

FIG. 4 is one embodiment of a detailed view of the holding part showing a magnetic connection.

FIG. 5A shows one embodiment of the virtual steering apparatus at a steady state configuration.

FIG. 5B-5C show two embodiments of the virtual steering apparatus at two steering configurations.

### DETAILED DESCRIPTION OF THE INVENTION

The presently disclosed virtual steering apparatus is intended for, but not exclusive to, mounting to an exercise bike for steering an associated digital bicycle in a digital cycling environment. The apparatus comprises at least two main parts; namely, a connection part and a holding part. In a preferred embodiment, the connection part may be adapted to be secured to the exercise bike, while the holding part may be connected to the connection part.

In an embodiment, the connection part is configured for attachment to the exercise bike such that the movement of the connection part is constrained whereas the holding part is free to rotate around a rotation axis defined by the rotation of the holding part relative to the connection part.

In the preferred embodiment, the virtual steering apparatus is configured to have a steady state configuration. Preferably, in the steady state configuration the connection part and the holding part define a first orientation relative to each other. This steady state configuration may also be referred to as a reference configuration. In an embodiment, when an external force is applied to the holding part, the holding part can rotate around the rotation axis. As a result, a second orientation of the holding part and the connection part may define a steering configuration. The steering configuration may be defined by means of steering, tilting or turning of the steering apparatus.

Hence, the first orientation may be the orientation that the apparatus maintains when there is no external force. In a further preferred embodiment, the virtual steering apparatus is configured to rotate back to the steady state configuration when the external force is removed. This foresees that the apparatus may go back to the reference configuration without an external force.

It is an advantage of the disclosed apparatus that the steering configuration can be obtained based on an external input and when the input is removed, the apparatus can return to the reference orientation and maintains the steady state configuration until another external force is applied. Thus, in an embodiment, the steady state configuration is maintained when there is no external force.

A further advantage of the presently disclosed apparatus is that, the apparatus may comprise at least one magnetic configuration to influence the function of rotating back to the first configuration and maintain the steering apparatus in the steady state configuration. In an embodiment, at least one magnet is provided in the steering apparatus and configured to effect the rotate back function, i.e. a function of rotating back is obtained. When the external force is removed, the pulling forces introduced by the magnetic configuration can rotate the apparatus to the reference orientation.

In an embodiment, the connection part and the holding part are magnetically joined. It was previously stated that the holding part can be configured to rotate relative to the connection part around a rotation axis and that the connection part can be secured to the exercise bike. Thus, providing a magnetic joint between the connection part and the holding part may have an advantage of securing the function of rotating back of the holding part around the rotation axis to go back to the first orientation, when the force on the holding part is removed.

In an embodiment, the rotation axis between the connection part and the holding part is defined by a shaft and a hole engagement. The shaft may be a part of the holding part and the hole may be a part of the connection part—or vice versa. Thus, when an external force is applied on the holding part, the shaft of the holding part can rotate within the hole of the connection part.

Thus, an advantage of the presently disclosed invention is that the connection part and the holding part can be joined mechanically by means of a shaft-hole engagement and magnetically by means of magnet(s). Joining of the connection part and the holding part may be arranged such that the rotation axis may be parallel to the pulling direction of the magnetic joint when the apparatus is at the steady state configuration. Thereby the connection part and the holding part can be easily assembled and disassembled, provide for easy rotation around the rotation axis and provides a slight resistance to the user while operating the steering apparatus and can also ensure that the steering apparatus automatically swings back to the steady state configuration.

In a further embodiment, the rotation axis is located in the centre of the apparatus. The location of the rotation axis may be configured such that the centre of mass of the apparatus is on the rotation axis. As a result, the apparatus can be subjected to the forces of similar magnitudes from each side of the rotation axis. In a further advantageous embodiment, the rotation axis may coincide a handlebar of the exercise bike. This foresees that the rotation axis may be parallel to the main horizontal frame of the exercise bike and the rotation axis may follow an axis similar to the axis defined by the front and end of the exercise bike.

In an embodiment, the connection part comprises at least one elongated steering member extending transversally from the rotation axis such that the steering configuration can be activated from many positions along a handlebar of the exercise bike.

In one embodiment, at least two elongated steering members can extend from the rotation axis such that at least one member may be accessible from one side, such as left side, of the handlebar while at least one member may be accessible from another side, such as right side, of the handlebar. This may indicate that the elongated members are parallel to or in a close-to-parallel configuration relative to the handlebar of an exercise bike, preferably below the handlebar.

In an embodiment, the apparatus comprises one, two or more sets of magnetically engaging elements facing each other in the steady state configuration. Based on various parameters such as the properties of the magnetic set(s), the length of the handlebar, applied force etcetera, the number of magnetic sets can be arranged.

In a further embodiment, the set(s) of magnetically engaging elements is located close to the rotation axis. This implies that the external force may be smaller compared to an external force that would be needed if the set(s) of magnetically engaging elements would be located further away from the rotation axis.

Additionally, the holding part is arranged to hold an electronic sensor unit. In an embodiment, the electronic sensor unit is a smartphone, mobile device, tablet, accelerometer or an electronic device adaptable to detect a direction of movement. An advantage of the present disclosure is that, when the steering apparatus is subjected to a force, the electronic sensor senses the steering configuration compared to the reference configuration. The relative steering configuration may be an indication of a steering direction for a virtual steering action.

In a further embodiment, the disclosed invention relates to a cycling exercise system. The system comprises the virtual steering apparatus and a computer program/software application. The software application can be executable on a remote processing device having a display unit. Preferably, the display unit can be a part of the electronic sensor unit. This foresees that the remote processing device is at least a part of the electronic sensor unit or vice versa.

In an embodiment, the display unit may be an external display or a screen or can be a part of a tablet or a mobile phone. This implies that the remote processing device can be connected to an external screen. Alternatively, the remote processing device comprises a display. Advantageously, a mobile phone or a tablet may comprise an electronic sensor for sensing the steady state and the steering configurations, and a display unit for displaying, and a processing device for executing a software application. Hence, the electronic sensor unit arranged on the holding part, the remote processing unit, the smartphone, and the display unit may be one and the same unit located on the steering apparatus just in front of the user. However, as also described in here, it may be several units.

In an embodiment, when the virtual steering apparatus is in the steering configuration, the software application can receive a tilting data from the electronic sensor unit attached to the holding unit of the apparatus. The tilting data may comprise the data related to the steering configuration of the virtual steering apparatus. The software application, aka the computer program, can process the tilting data by means of the remote processing device on which the software is executed. Furthermore, the software application can provide real-time steering data representing steering of a virtual bicycle in a virtual cycling game.

Thus, when an external force is applied on the virtual steering apparatus, the electronic sensor can sense the steering configuration and the software application can receive and identify the data related to the steering configuration. Advantageously, the data related to the steering configuration of the apparatus can determine the steering of a virtual bike in a virtual environment.

A further advantage of the disclosed cycling exercise system is that the system can display virtual track-based location information of the digital bicycle in real time on the display unit. In an embodiment, the virtual location information comprises a position information on the digital track of the digital bicycle generated in a digital space of the digital cycling game. The digital bicycle can follow a digital track in a digital environment of a digital cycling game or a digital cycling exercise.

The position information of the digital bicycle may be subjected to change. Based on a virtual location information of the digital bicycle, steering of the digital bicycle may be necessary. This implies that in an embodiment, the disclosed cycling exercise system can be configured to control steering of the digital bicycle based on the positional information of the digital bicycle.

In an advantageous embodiment, the disclosed system can be configured for receiving, processing and transmitting the real-time steering data of the digital bicycle. Preferably, the steering of the digital bicycle in the digital cycling game may be associated with the tilting data received by the electronic sensor unit. While the tilting data may be imposed on the electronic sensor unit or to the application by an input, one of the main aspects of the disclosed invention is to relate an actual tilting or turning action with a digital steering action.

Thus, in a further preferred embodiment, steering of the digital bicycle riding on the digital track may be based on an external force applied on the holding part.

Furthermore, it is foreseen that in a preferred embodiment, an operator or a user of the system can apply an external force on the elongated member of the holding part of the virtual steering apparatus.

Advantageously, the operator can involve in a decision-making process because the action of tilting or turning the holding part can be initiated by the operator if there is a need for a steering action in the digital game. Furthermore, the steering action of the holding part is similar to what the operator would do in a real cycling exercise or a game. As a result, the operator may have an enhanced feeling of participating in an actual cycling activity.

Furthermore, it is foreseen that in a preferred embodiment, when the holding part tilts (rotates, turns), the virtual bicycle in communication with the electronic sensor unit can turn to the detected direction of the tilt.

This may imply that the holding part may be approached from at least one direction and can be tilted to at least one direction. Preferably, the tilting direction of the holding part may correspond to the steering direction of the virtual bicycle. More preferably, the clockwise steering of the holding part may correspond to a right turn while the left turn may be indicated by turning the holding part counter-clockwise when looking from the user's point of view.

Steering of the presently disclosed steering apparatus can also be associated with lane shifting in the digital cycling game, i.e. when the holding part tilts (or turns or rotates). E.g. a short activation of the steering apparatus may be associated with a shift of lane position in the digital cycling game, e.g. gaining a new position of the digital bicycle in a a peloton in the digital cycling game. By means of the same steering apparatus, both steering and lane shifting functions can be defined. Therefore, the disclosed invention provides a user-friendly and compact design serving for at least both steering and the lane shifting actions at various directions in digital cycling games.

In an embodiment, a virtual cyclist can ride on the virtual bicycle. This feature may enhance the reality of the game and improve the joy and engagement of the operator while using the disclosed system.

In another embodiment, an exercise bike comprising the disclosed cycling exercise system may have the virtual steering apparatus secured to the handlebar of the exercise bike such that the handlebar of the exercise bike can be stationary during tilting and tilting back of the holding part. A great advantage of this feature is that the steering action of the virtual bike can be defined by an actual tilting or turning action while keeping the exercise bike stationary. Thus, the disclosed cycling exercise system can be suitable for various stationary exercise bikes.

Furthermore, it is foreseen that in a preferred embodiment, the user or the operator of the exercise bike, or a stationary exercise bike, can apply an external force on the holding part, preferably on the elongated member, of the virtual steering apparatus. Advantageously, an operator of the exercise bike can access the elongated member while operating the exercise bike. The operator may reach to the steering members while holding the handlebar of the exercise bike. Thus, the operator can have a better control of the steering apparatus.

Consequently, the force applied on the steering apparatus may be a result of an action of touching the elongated steering member of the apparatus. Thus, the presently disclosed exercise bicycle can be configured to effectively turn or steer the virtual bike or change the lane of the virtual bike while performing a demanding real life situation such as riding in wind, uphill, downhill, etcetera.

### DETAILED DESCRIPTION OF THE DRAWINGS

The present disclosure will now be described more fully hereinafter with reference to the accompanying exemplary embodiments shown in the drawings, when applicable.

However, it is to be noted that the invention may be embodied in various forms. The hereby provided embodiments are to guide a thorough and complete disclosure.

Hence, embodiments set forth herein should not be interpreted as limiting but be construed as a tool for delivering the scope of the invention to those who are skilled in the art. The same reference numbers refer to the same element throughout the document.

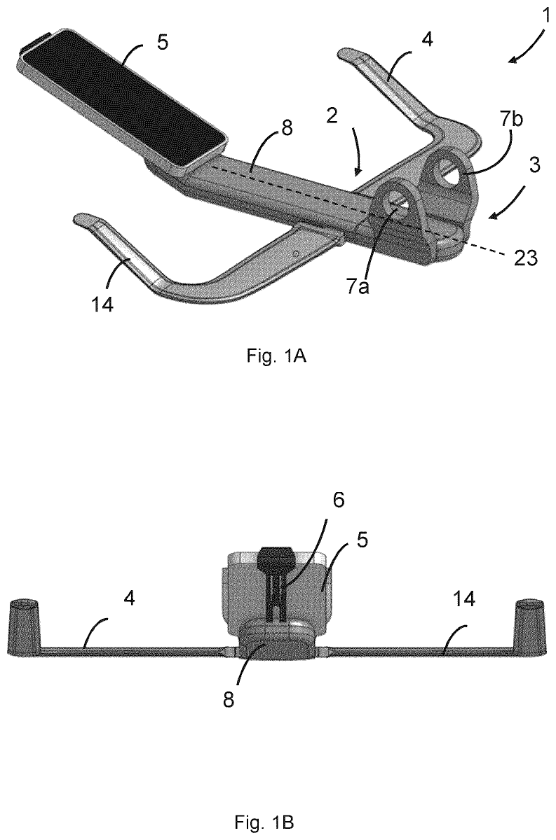

FIG. 1A shows one embodiment of an isometric view of the virtual steering apparatus 1, comprising a connection part 3 and a holding part 2. From one end, the connection part 3 is configured to be secured to a training apparatus such as an exercise bike, e.g. in the form of a smart trainer (not shown). From the other end, further away from the exercise bike, the connection part 3 is connected to the holding part 2. The holding part 2 can rotate relative to the connection part 3 around a rotation axis 23, such that the rotation axis cuts the horizontal plane of the connection part 3 and a holding part 2 symmetrically.

Furthermore, the holding part 2 extends along the rotation axis 23, defining a main body 8. FIG. 1B shows one embodiment of a back view of the virtual steering apparatus. The main body 8, comprising an adjustable-longitudinal leg 6, extends further along the rotation axis and is configured for holding an electronic sensor unit, such as a smartphone 5. The length of the adjustable-longitudinal leg 6 can be adjusted so that electronic sensor unit, such as a smartphone 5 of various sizes can fit in. Furthermore, the holding part comprises elongated steering members 4, 14 extending transversally from the rotation axis 23.

In a steady state configuration as shown in FIG. 1A and FIG. 1B, the connection part 3 and the holding part 2 define a first orientation relative to each other. When an external force is applied to the holding part 2, the holding part rotates relative to the connection part around the rotation axis 23. The external force may be applied to the elongated steering members 4, 14 of the holding part 2.

The steering apparatus can be secured to the exercise bike by means of one or more circular openings 7a, 7b on the connection part 3. The circular openings 7a, 7b are holes on a surface extending away from a rotation axis 23 of the holding part 2. The circular openings 7a, 7b extend from each side of the connection part 3, and face each other and are configured such that a handlebar of a bicycle (not shown) passing through the circular holes 7a, 7b can be held, thereby securing the steering apparatus to the handlebar.

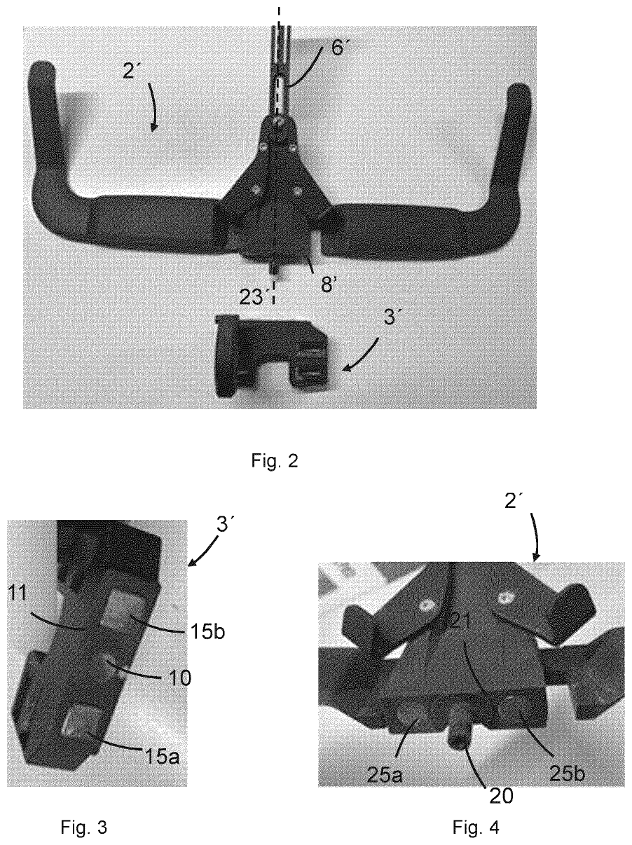

FIG. 2 shows another embodiment of the virtual steering apparatus. In this embodiment, the connection part 3′ and the holding part 2′ are disassembled. The main body 8′ of the holding part 2′ is shorter than the main body 8 shown in FIG. 1A. The rotation axis 23′ between the connection part 3 and the holding part 2′ is defined by a shaft-hole engagement.

FIG. 3 is an embodiment of the connection part 3′ showing an engagement surface 11 where the connection part 3′ engages with the holding part. The connection part 3′ comprises a cylindrical hole 10 elongating along the rotation axis of the steering apparatus for an engagement with a cylindrical rod 20 shown in FIG. 4. The cylindrical rod 20 elongates from an engagement surface 21 of the holding part 2′ along the rotation axis. Tolerances of the shaft-hole engagement is provided such that the cylindrical rod 20 can rotate within the cylindrical hole 10.

FIG. 3 and FIG. 4 further show an embodiment of the magnetic connection. The connection part 3′ is provided with two magnetic elements 15a, 15b embedded on the engagement surface 11 at each side of the cylindrical hole 10. Similarly, the holding part 2′ is provided with two magnetic elements 25a, 25b embedded in the engagement surface 21 at each side of the cylindrical rod 20. The magnetic elements 15a, 15b, 25a, 25b are equidistant from the centre of rotation defined by the engagement of the cylindrical rod 20 and the cylindrical hole 10.

In an embodiment, the magnetic elements 15a, 15b embedded in the connection part 3′ face the magnetic elements 25a, 25b embedded in the holding part 2′ approximately 5-25 mm away from the rotation axis of the steering apparatus.

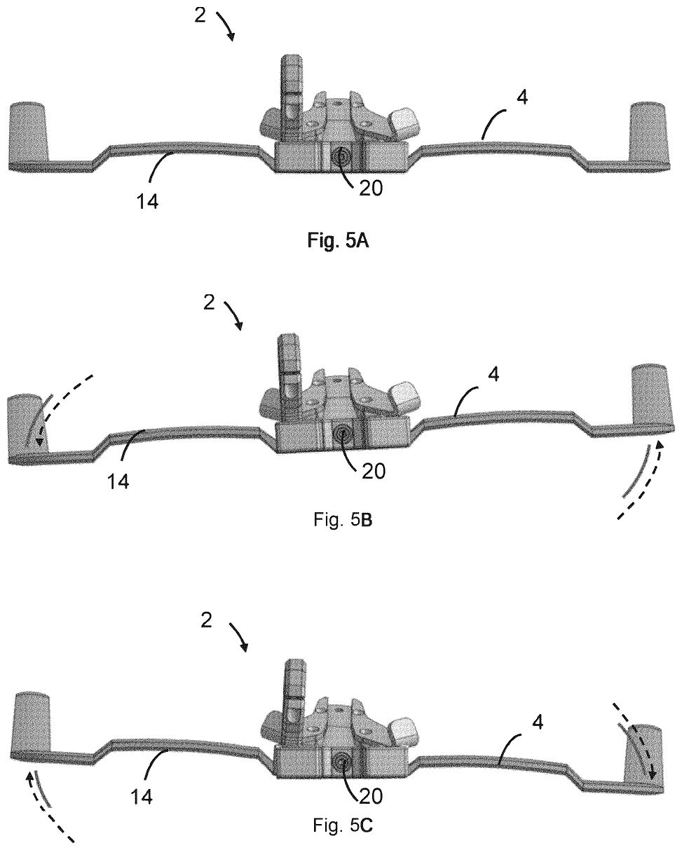

In one embodiment of the virtual steering apparatus, shown in FIG. 5A, steering members 4, 14 extend symmetrically from the rotation axis defined by the cylindrical rod-hole engagement. At a steady state configuration, when looking from the user's point of view, the steering members extend from the cylindrical rod 20 with a similar distance to user or the handlebar of the exercise bike.

Virtual steering apparatus is configured to provide a steering configuration wherein an external force applied to the holding part 2 rotates the holding part 2 around the rotation axis of the virtual steering apparatus. The direction of the force applied to the steering member for steering the holding part 2 towards left and right may be as shown with dotted lines in FIGS. 5B and 5C respectively. In one embodiment, steering configuration for steering the exercise bike thereby the virtual bike to the left when looking from the user's point of view may be obtained by applying a force to any of the steering members 4, 14. Preferably, the left steering member 4 may be pushed downwards or the right steering member 14 may be moved upwards relative to the configuration at steady state. FIG. 5C is one embodiment of the virtual steering apparatus at a steering configuration for turning right when looking from the user's point of view. For defining a steering configuration towards right, the user may apply a force such that the left steering member 4 moves upwards and/or the right steering member 14 moves downwards. In an alternative embodiment, the direction of the external force applied to the holding part for obtaining a steering configuration may be forwards or backwards or can be any other direction if the sensor unit and/or the magnetic engagements are accordingly adjusted.

Items
1. A virtual steering apparatus for an exercise bike comprising:
   a connection part adapted to be secured to the exercise bike,
   a holding part connected to the connection part and configured for holding an electronic sensor unit, such as a smartphone, and
   a rotation axis between the connection part and the holding part,
   wherein the virtual steering apparatus is configured to have a steady state configuration where the connection part and the holding part define a first orientation relative to each other, and a steering configuration wherein an external force applied to the holding part rotates the holding part relative to the connection part around the rotation axis of the virtual steering apparatus.
2. An apparatus according to item 1, configured to rotate back to the steady state configuration when the external force is removed.
3. An apparatus according to item 2, comprising at least one magnet configured to effect the rotate back function.
4. An apparatus according to any of the preceding items, configured such that the steady state configuration is maintained when there is no external force.
5. An apparatus according to any of the preceding items, wherein the connection part and the holding part are magnetically joined.
6. An apparatus according to any of the preceding items, wherein the rotation axis is located in a center of the apparatus.
7. An apparatus according to any of the preceding items, wherein the rotation axis between the connection part and the holding part are defined by a shaft and hole engagement.
8. An apparatus according to any of the preceding items, comprising one, two or more sets of magnetically engaging elements facing each other in the steady state configuration.
9. An apparatus according to item 8, wherein the set(s) of magnetically engaging elements is located close to the rotation axis.
10. An apparatus according to any of the preceding items, wherein the connection part comprises at least one or two elongated steering members extending transversally from the rotation axis such that the steering configuration can be activated from a handlebar of the exercise bike.
11. An apparatus according to any of the preceding items, wherein the electronic sensor unit is a smartphone, mobile device, tablet, accelerometer or an electronic device, and wherein the electronic sensor unit if configured for detecting a direction of movement of the electronic sensor unit, a direction of movement such a rotation and/or tilt.
12. A cycling training system comprising the virtual steering apparatus according to any of the preceding items and a computer program having instructions, which, when executed by a processing unit, cause the processing unit to:
   receiving the tilting data from an electronic sensor unit attached to the holding unit of the virtual steering apparatus, when the virtual steering apparatus is in the steering configuration,
processing the tilting data by means of the remote processing device to provide real-time steering data representing steering of a virtual bicycle in a virtual cycling game.
13. A cycling exercise system according to item 12, comprising a display unit for displaying the virtual cycling game and wherein the display unit is a part of the electronic sensor unit, an external display, a screen, a tablet or a mobile phone.
14. A cycling exercise system according to items 12-13, configured to display a virtual track based location information of the virtual bicycle in real time on the display unit.
15. A cycling exercise system according to item 14, wherein the virtual location information comprises a position information on the virtual track of the virtual bicycle generated in a virtual space of the virtual cycling game.
16. A cycling exercise system according to item 15, configured to control steering of the virtual bicycle based on the position information of the virtual bicycle.
17. A cycling exercise system according to items 12-16, configured for receiving, processing and transmitting the real-time steering data of the virtual bicycle, such that the steering of the virtual bicycle in the virtual cycling game is associated with the tilting data received by the electronic sensor unit.
18. A cycling exercise system according to items 12-17, wherein steering of the virtual bicycle riding on the virtual track is based on the external force applied on the holding part.
19. A cycling exercise system according to items 12-18, configured such that, when the holding part tilts, the virtual bicycle in communication with the electronic sensor unit turns to the detected direction of the tilt.
20. A cycling exercise system according to items 12-18, configured such that, when the holding part tilts, the virtual bicycle in communication with the electronic sensor unit shifts lane in the virtual cycling game.
21. A cycling exercise system according to items 12-20, wherein a virtual cyclist ride on a virtual bike.
22. An exercise bike comprising the cycling exercise system according to items 12-21, wherein the virtual steering apparatus is secured to a handlebar of the exercise bike such that the handlebar of the exercise bike can be stationary during tilting and tilting back of the holding part.
23. An exercise bike according to item 22, configured such that a user of the exercise bike can apply an external force on the holding part of the virtual steering apparatus.

What is claimed is:

1. A virtual steering apparatus for attachment to a handlebar of an exercise bike comprising:
a connection part adapted to be secured to the handlebar of the exercise bike; and
a holding part connected to the connection part and configured for holding an electronic sensor unit;
wherein the virtual steering apparatus is configured to have a steady state configuration where the connection part and the holding part define a first orientation relative to each other, and a steering configuration wherein an external force applied to the holding part rotates the holding part relative to the connection part around the rotation axis of the virtual steering apparatus such that the handlebar of the exercise bike is stationary during rotation of the holding part.

2. The apparatus of claim 1, configured to rotate back to the steady state configuration when the external force is removed.

3. The apparatus of claim 2, comprising at least one magnet configured to effect the rotate back function.

4. The apparatus of claim 1, configured such that the steady state configuration is maintained when there is no external force.

5. The apparatus of claim 1, wherein the connection part and the holding part are magnetically joined.

6. The apparatus of claim 1, wherein the rotation axis between the connection part and the holding part is defined by a shaft and hole engagement.

7. The apparatus of claim 1, comprising one or more sets of magnetically engaging elements facing each other in the steady state configuration and wherein the set(s) of magnetically engaging elements is located close to the rotation axis.

8. The apparatus of claim 1, wherein the connection part comprises at least one elongated steering member extending transversally from the rotation axis such that the steering configuration can be activated from a handlebar of the exercise bike.

9. The apparatus of claim 1, wherein the electronic sensor unit is one of a smartphone, mobile device, tablet, accelerometer, and an electronic device, and wherein the electronic sensor unit is configured for detecting a direction of movement of the electronic sensor unit.

10. A cycling exercise system, comprising:
a virtual steering apparatus for attachment to a handlebar of an exercise bike comprising
a connection part adapted to be secured to the handlebar of the exercise bike; and
a holding part connected to the connection part and configured for holding an electronic sensor unit;
wherein the virtual steering apparatus is configured to have a steady state configuration where the connection part and the holding part define a first orientation relative to each other, and a steering configuration wherein an external force applied to the holding part rotates the holding part relative to the connection part around the rotation axis of the virtual steering apparatus such that the handlebar of the exercise bike is stationary during rotation of the holding part; and
a non-transitory computer readable medium holding a computer program comprising instructions, which, when executed by a processing unit, cause the processing unit to
receive tilting data from an electronic sensor unit attached to the holding unit of the virtual steering apparatus, when the virtual steering apparatus is in the steering configuration; and
process the tilting data by means of the remote processing device to provide real-time steering data representing steering of a virtual bicycle in a virtual cycling game.

11. The cycling exercise system of claim 10, comprising a display unit for displaying the virtual cycling game and wherein the display unit is a part of the electronic sensor unit, an external display, a screen, a tablet or a mobile phone and wherein the system is configured to display a virtual track based location information of the virtual bicycle in real time on the display unit, wherein the virtual location information comprises a position information on the virtual track of the virtual bicycle generated in a virtual space of the virtual cycling game and wherein the system is configured to control steering of the virtual bicycle based on the position information of the virtual bicycle.

12. The cycling exercise system of claim 10, configured for receiving, processing and transmitting the real-time steering data of the virtual bicycle, such that the steering of the virtual bicycle in the virtual cycling game is associated with the tilting data received by the electronic sensor unit and wherein steering of the virtual bicycle riding on the virtual track is based on the external force applied on the holding part.

13. The cycling exercise system of claim 10, configured such that, when the holding part tilts, the virtual bicycle in communication with the electronic sensor unit shifts lane in the virtual cycling game.

14. The cycling exercise system of claim 10, wherein a virtual cyclist rides on a virtual bike.

15. The cycling exercise system of claim 10, further comprising:
an exercise bike, wherein the virtual steering apparatus is secured to a handlebar of the exercise bike such that the handlebar of the exercise bike is stationary during tilting and tilting back of the holding part.
